(19) United States
(12) Patent Application Publication
(10) Pub. No.: US 2004/0098318 A1
(43) Pub. Date: May 20, 2004

(54) Method of buying back goods that both improves efficiency and eases the burden on users

(76) Inventor: Michihisa Furukawa, Tokyo (JP)

Correspondence Address: YOUNG & THOMPSON, 745 SOUTH 23RD STREET 2ND FLOOR, ARLINGTON, VA, 22202

(21) Appl. No.: 10/647,311

(22) Filed: Aug. 26, 2003

(30) Foreign Application Priority Data
Aug. 26, 2002 (JP) 2002-244934

(51) Int. Cl. G06F 17/60

(52) U.S. Cl. 705/26

(57) ABSTRACT

In the method of buying back goods of the present invention, a buy-back center directs users to enter as input the order numbers of goods that the users have purchased through a specific sales center and accepts applications for buying back used items and participation in a campaign. The buy-back center, after obtaining confirmation by means of the above-described order numbers that the users have purchased goods through the sales center, gives prescribed benefits to the users.

### BACKGROUND OF THE INVENTION

1. Field of the Invention

The present invention relates to a method of buying back goods, a system for buying back goods, a sales server, and a buy-back server.

2. Description of the Related Art

The conventional mode of marketing has been to supply goods to a marketing site such as a store or shop and then to market the goods at this store. In recent years, however, the spread of the use of networks such as the Internet has popularized a marketing mode in which goods are marketed at Web sites on the network.

However, marketers of goods on websites on networks also have a need to encourage users who already own targeted goods to switch to new products. On the other hand, when switching to a new product of targeted goods, users also have a need for having the unnecessary used item bought back.

According to one method for buying back goods that meets the above-described needs of both marketers and users, the marketer awards prescribed benefits (cash rebates, points, or giveaways) to users who purchase a new item of targeted goods on the marketer's Website and who allow a buyer that has been designated by the marketer to buy back the user's used item.

According to this method, the user enjoys the advantages of being able to have unnecessary items bought back, and also of obtaining the above-described benefits. The marketers, on the other hand, enjoy the advantage of being able to encourage users to switch to new items of targeted goods.

Effecting this type of method for buying back goods is further advantageous because users who have used items bought back can then use the money obtained by these transactions as a resource for purchasing new goods and thus can be relieved of a portion of the financial burden. However, when the goods in question are personal computers (hereinbelow abbreviated as PCs), the used items are preferably sold off after the new items have been purchased for the reason that it is necessary to shift data from the used item to the new item or that it is necessary to purchase the new items on the network.

As one method of the prior art for buying back goods, we next refer to FIG. 1 to explain a method for buying back goods that takes as its object a user who has first purchased a new PC. The method of buying back goods that is shown in FIG. 1 is a method by which a prescribed cash rebate is awarded to a user who has purchased a new item, a PC, on the Website of a marketer (hereinbelow referred to as sales center) 200 and who allows a buyer (hereinbelow referred to as buy-back center) 300 that has been designated by sales center 200 to purchase a user's used PC. Sales center 200 and buy-back center 300 may be separate enterprises, or may be the same enterprise.

First, in Step A201, sales center 200 announces on the Website that is operated on a network by sales center 200 that it is putting into effect a buy-back campaign that targets users who purchase new PCs at sales center 200 in which users are awarded a prescribed cash rebate if they allow buy-back center 300 to buy back their used PCs.

In Step A202, user 100 next uses user terminal 110 to access the Website of sales center 200, checks the content of the above-described buy-back campaign on this Website, and based on this information, enters prescribed personal data (such as name, address, telephone number, and e-mail address) and the maker and model number of the new article that user 100 wishes to purchase, and thus submits an application to purchase the new article.

Next, in Step A203, sales center 200 withdraws the amount payable for the new item that user 100 wishes to buy from the account designated by user 100 and then supplies the new item to user 100. At this time, sales center 200 gives user 100 a sales certificate (which can be substituted by a delivery statement or guarantee certificate) that certifies that user 100 has purchased a new item from sales center 200. This certificate may, for example, be applied to the packaging of the new item.

In Step A204, user 100 uses user terminal 110 to access the Website of buy-back center 300, and at this Website, performs a preliminary estimation of the buy-back price of the used item by entering information such as the maker and model number of the used item. The preliminary estimation of the buy-back price by user 100 may also be carried out when user 100 checks the particulars of the buy-back campaign in Step A202.

If user 100 consents to the buy-back price that has been obtained in the preliminary estimation, user 100 next enters prescribed personal data (such as name, address, telephone number, e-mail address) and information such as the maker and model number of the used item that user 100 wishes to have bought back in the Website of buy-back center 300 in Step A205, and applies for buy-back of the used item.

In Step A206, the used item of user 100 is collected at buy-back center 300 by, for example, having user 100 bring in the item, having the user send in the item, or by dispatching someone to the residence or company of user 100 to claim the item.

Next, in Step A207, the used item that has been collected from user 100 is assessed at buy-back center 300 to determine the final buy-back price, and the amount of this buy-back price is then transferred to the account that has been specified by user 100. Buy-back center 300 also delivers to user 100, either directly or by, for example, the postal system, a buy-back certificate certifying that user 100 has allowed buy-back center 300 to buy back the used item.

In Step A208, user 100 uses user terminal 110 to again access the Website of sales center 200, and at this Website, downloads and obtains the campaign application form. User 100 then enters prescribed personal data (name, address, telephone number, e-mail address, etc.) into this application form and sends the completed form together with the sales certificate that was provided from sales center 200 and the buy-back certificate that was provided from buy-back center 300 to sales center 200 by means of, for example, the postal system.

In Step A209, sales center 200 subsequently verifies that the campaign application form, the sales certificate, and the purchase certificate that have been sent from user 100 satisfy the conditions of the buy-back campaign, and then transfers the prescribed cash rebate amount to the account that was specified by user 100.

Nevertheless, the method of buying back goods of the prior art that is shown in FIG. 1 has the following problems.

A first problem is that no information is exchanged between the sales center and buy-back center regarding new items that have been purchased by users or the used items that user allow to be bought back. As a result, the buy-back center, when seeking to obtain information regarding new items that users have purchased at the sales center, must carry out a separate inquiry to the sales center, and the process of buying back items therefore cannot be carried out efficiently. The sales center can obtain information regarding used items that the buy-back center has bought back from users by means of the buy-back certificate that accompanies the application forms for participation in the buy-back campaign.

A second problem is the increase in the number of applications that results from the requirement for a user to fill out a total of three applications: the application to purchase a new item, the application for buy-back of a used item, and the campaign application. With each application, the user must enter personal data such as user's name, and this increases the burden on the user.

### SUMMARY OF THE INVENTION

It is an object of the present invention to provide a method of buying back goods, a system for buying back goods, a sales server, and a buy-back server by which goods can be bought back more efficiently and the burden on users can be eased.

According to the method of buying back goods of the present invention for achieving the above-described objects, a user that has purchased an article at a specific sales center is provided with a prescribed benefit on the condition that a buy-back center buys a used item from the user. In this case, the buy-back center accepts an application for buy-back in which the user is directed to enter as input the order number of an item that the user has purchased at the sales center.

Accordingly, based on the order number, the buy-back center is able to obtain confirmation that the user has purchased an article at the sales center. The buy-back center is therefore able to accept the application for obtaining the prescribed benefit at the same time that it accepts the application for buy-back, and as a result, the number of applications relating to the buy-back campaign can be reduced to a total of two; one when buying a new item and one when having a used article bought back. The present invention therefore allows a reduction of the number of applications in comparison to the prior art, in which the number of applications relating to a buy-back campaign was three, and accordingly, the present invention can reduce the burden on the user.

In addition, the buy-back center can also obtain from the sales center information relating to the user based on the order number that the user is directed to enter as input when applying for buy-back. The buy-back center can therefore process the buying back of goods more efficiently. For example, as one advantage obtained from that the buy-back center has information on an item purchased by the user, when the buy-back center wishes to focus on buying back items that are in great demand for resale, the buy-back center can quickly discover the users that have these items.

The above and other objects, features, and advantages of the present invention will become apparent from the following description with reference to the accompanying drawings, which illustrate examples of the present invention.

### BRIEF DESCRIPTION OF THE DRAWINGS

FIG. 1 is an explanatory view of a method of buying back goods of the prior art.

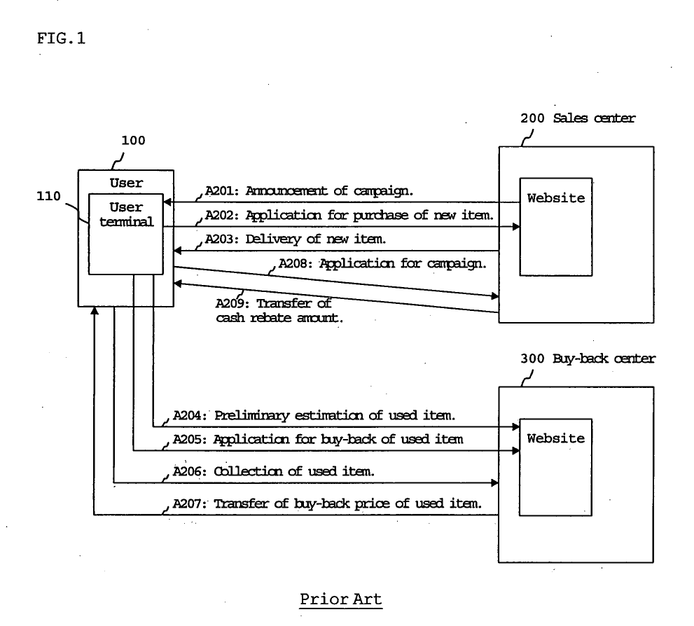

FIG. 2 shows a system for buying back goods that is used in the method of buying back goods according to the first and third embodiments of the present invention.

FIG. 3 is an explanatory view of the method of buying back goods according to the first embodiment of the present invention.

FIG. 4 is a view for explaining the linked images of the Websites that are operated by the sales center and buy-back center that are shown in FIG. 2.

FIG. 5 is a flow chart for explaining the details of the procedures up to the application for participating in the campaign in the method of buying back goods according to the first embodiment of the present invention.

FIG. 6 is a flow chart for explaining the details of the procedures following the application for participation in the campaign in the method of buying back goods according to the first embodiment of the present invention.

FIG. 7 is a view for explaining the image of a preliminary estimation page on the Website that is operated by the buy-back center that is shown in FIG. 2.

FIG. 8 is a view for explaining the image of a buy-back/campaign application page on the Website that is operated by the buy-back center that is shown in FIG. 2.

FIG. 9 shows the system for buying back goods that is used in the method of buying back goods according to the second and fourth embodiments of the present invention.

FIG. 10 is a view for explaining the method of buying back goods according to the second embodiment of the present invention.

FIG. 11 is a view for explaining the method of buying back goods according to the third embodiment of the present invention.

FIG. 12 is a view for explaining the method of buying back goods according to the fourth embodiment of the present invention.

### DETAILED DESCRIPTION OF THE PREFERRED EMBODIMENTS

The present invention can be applied for various types of goods, but the explanation in the following description takes as an example a case in which the targeted goods are personal computers (hereinbelow abbreviated PCs).

First Embodiment

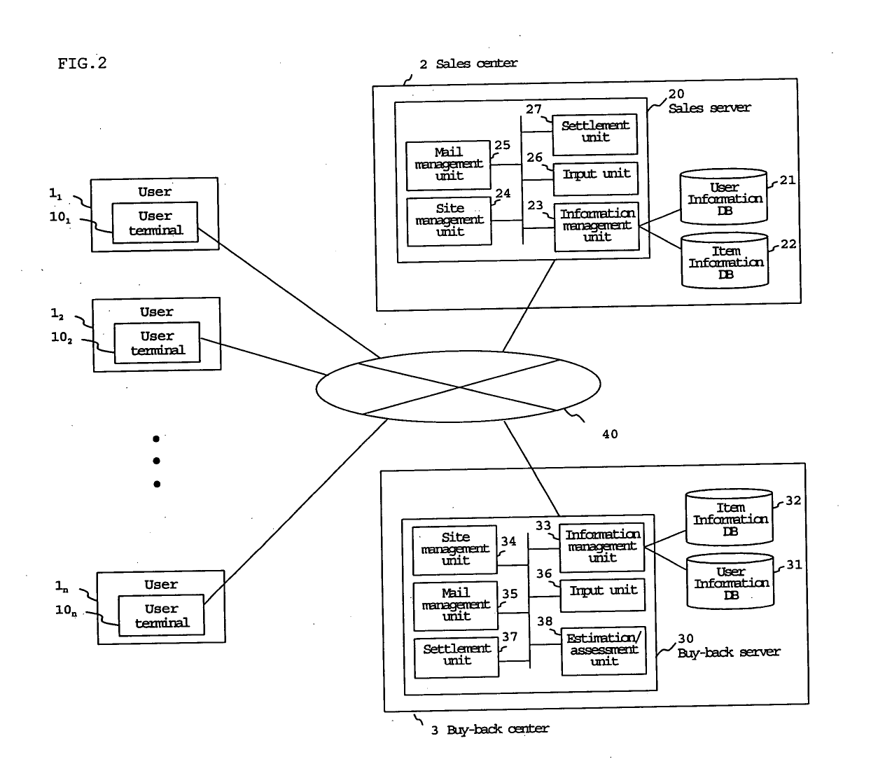

The method of buying back goods according to the first embodiment of the present invention is implemented by using the system for buying back goods that is shown in FIG. 2.

The system for buying back goods that is shown in FIG. 2 is provided with: user terminals 10₁-10ₙ that are each used by users 1₁-1ₙ respectively; sales center 2 for marketing new PC items to each of users 1₁-1ₙ and that is provided with sales server 20, user information DB (database) 21, and item information DB 22; and buy-back center 3 for buying back used PC items from each of users 1₁-1ₙ and that is provided with buy-back server 30, user information DB 31, and item information DB 32.

User terminals 10₁-10ₙ sales server 20 that is provided in sales center 2, and buy-back server 30 that is provided in buy-back center 3 are all interconnected by way of network 40.

User information DB 21 and item information DB 22 may be provided in sales server 20; and user information DB 31 and item information DB 32 may be provided in buy-back server 30.

Sales center 2 and buy-back center 3 may be provided in separate enterprises, or may be provided in the same enterprise.

Explanation next regards the construction of sales server 20 and buy-back server 30.

Sales server 20 includes information management unit 23, site management unit 24, mail management unit 25, input unit 26, and settlement unit 27.

Information management unit 23 manages user information DB 21 and item information DB 22. For example, personal data such as the names, addresses, telephone numbers, e-mail addresses of each of users 1₁-1ₙ that have purchased new items from sales center 2 and information regarding the new items that each of users 1₁-1ₙ purchase are registered in user information DB 21 in correspondence with the order numbers of the new items. In addition, information such as the sales prices of new items that are marketed by sales center 2 and information regarding benefits (cash rebates, points, or giveaways) that are awarded to each of users 1₁-1ₙ that participate in the buy-back campaign (to be explained hereinbelow) are registered in item information DB 22.

Site management unit 24 produces and manages each of the pages of a Website that is operated on network 40 by sales center 2.

Mail management unit 25 not only transmits and receives electronic mail between user terminals 10₁-10ₙ and buy-back server 30 of buy-back center 3 by way of network 40, but also produces and manages the electronic mail that is transmitted and received.

Input unit 26 is a keyboard or mouse for entering various types of information as input, and for example, is used for entering information that is posted on each of the pages of the Website that is produced by site management unit 24 or information that is described in electronic mail that is produced by mail management unit 25.

Settlement unit 27 carries out settlement processing of the purchase amounts of new items that are purchased by each of users 1₁-1ₙ by, for example, withdrawing funds from accounts that are designated by each of users 1₁-1ₙ.

Buy-back server 30 includes information management unit 33, site management unit 34, mail management unit 35, input unit 36, settlement unit 37, and estimation/assessment unit 38.

Information management unit 33 manages user information DB 31 and item information DB 32. For example, personal data such as the names, addresses, telephone numbers, and e-mail addresses of each of users 1₁-1ₙ that have allowed buy-back center 3 to buy back used items and information regarding the used items that have been bought back from each of users 1₁-1ₙ are registered in user information DB 31. Information regarding the buy-back prices of used items that buy-back center 3 buys back is registered in item information DB 22.

Site management unit 34 produces and manages each of the pages of a Website that is operated on network 40 by buy-back center 3.

Mail management unit 35 not only transmits and receives electronic mail between user terminals 10₁-10ₙ and sales server 20 of sales center 2, but also produces and manages the electronic mail that is transmitted and received.

Input unit 36 is, for example, a keyboard or mouse for entering various types of information as input, and is used for entering, for example, information that is posted on each of the pages of the Website that is produced by site management unit 34, information that is described in electronic mail that is produced by mail management unit 35, and the makers or model numbers of used items when assessing the used items of each of users 1₁-1ₙ.

Settlement unit 37 performs a process of settling the buy-back prices of used items that are bought back from each of users 1₁-1ₙ by, for example, transferring funds to the accounts that are designated by each of users 1₁-1ₙ. In addition, when providing cash rebates to users 1₁-1ₙ that participate in a campaign, settlement unit 37 performs a process of settling the cash rebate amount by, for example, transferring the cash rebate amount to the accounts that have been designated by users 1₁-1ₙ.

Estimation/assessment unit 38 calculates the buy-back prices of used items based on information that is applied as input in the Website of buy-back center 3 when users 1₁-1ₙ perform a preliminary estimation of the value of used items (details to be explained hereinbelow) and information that is applied as input to input unit 36 when buy-back center 3 assesses the value of used items.

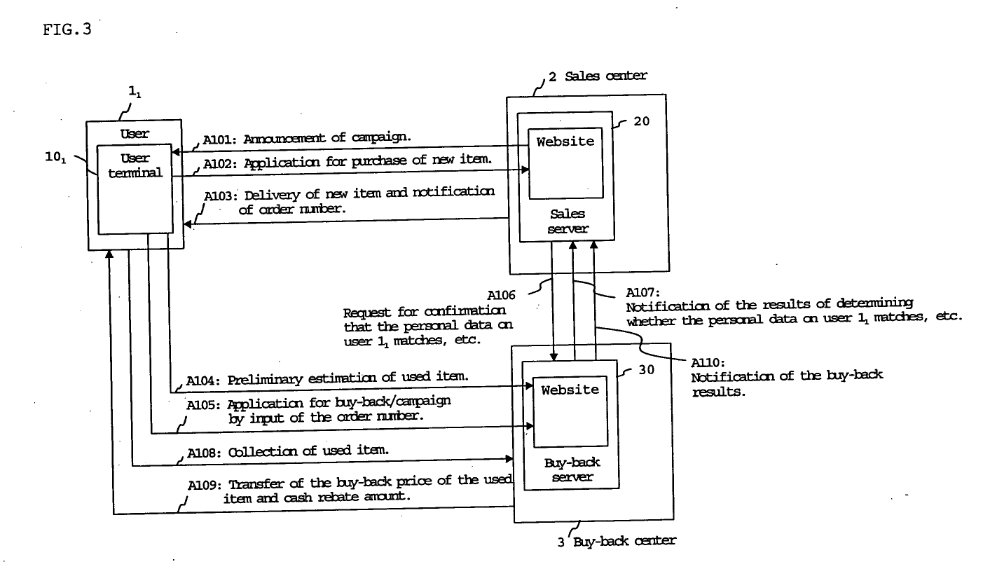

We next refer to FIG. 3 to explain the method of buying back goods according to the first embodiment of the present invention. The method of buying back goods that is shown in FIG. 3 is a method for providing prescribed cash rebate amounts to users 1₁-1ₙ when these users 1₁-1ₙ, who have purchased new PCs on the Website of sales center 2, allow buy-back center 3 that is designated by sales center 2 to buy back used PCs. In this case, explanation regards user 1₁ who is participating in the buy-back campaign.

First, in Step A101, site management unit 24 in sales center 2 announces on a Website that is operated on network 40 by sales center 2 the institution of a buy-back campaign that targets users 1₁-1ₙ who have purchased new PCs at sales center 2 and that awards prescribed cash rebate amounts to these users on the condition that these users 1₁-1ₙ allow buy-back center 3 to buy back PCs that they own.

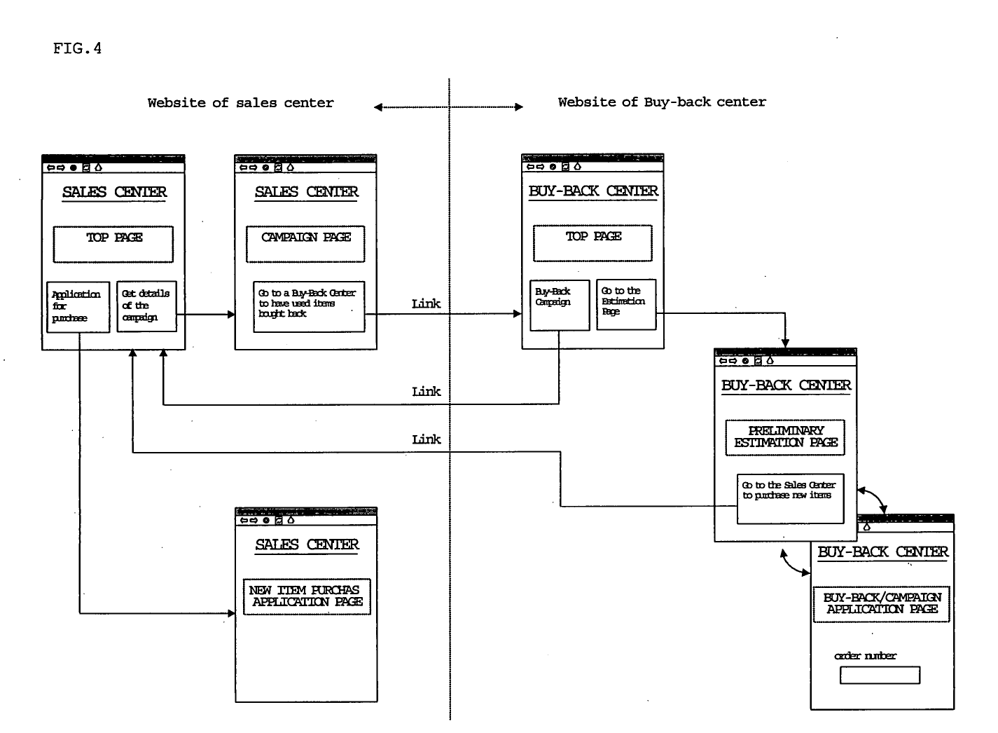

To describe more specifically, we next refer to FIG. 4. Site management unit 24 of sales center 2 publishes on the top page of the Website of sales center 2 an announcement of the institution of a buy-back campaign and allows a user to jump from this top page to a campaign page that posts in detail the particulars of the buy-back campaign. Site management unit 24 further links this campaign page to a Website that is operated by buy-back center 3 on network 40, and allows a user to jump to the top page of buy-back center 3. Site management unit 24 also allows a user to jump from the top page of sales center 2 to a new item purchase application page for applying to purchase a new item.

Site management unit 34 of buy-back center 3, on the other hand, announces on the top page of the Website of buy-back center 3 that a buy-back campaign is in effect at the Website of sales center 2. Site management unit 34 further links the top page of buy-back center 3 to the Website of sales center 2 and allows a user to jump to the top page of sales center 2. Site management unit 34 also allows a user to jump from the top page of buy-back center 3 to a preliminary estimation page that allows a user to estimate the buy-back price of a used item by himself or herself. Site management unit 34 also links this preliminary estimation page to the Website of sales center 2 to allow a user to jump to the top page of sales center 2. Site management unit 34 further allows a user to jump from this preliminary estimation page to a buy-back/campaign application page for enabling a user to apply for buy-back of an item user 1₁ owns and to apply for participation in the campaign.

Next, in Step A102, user 1₁ uses user terminal 10₁ to access the Website of sales center 2 and consult the above-described campaign page to check the particulars of the buy-back campaign. User 1₁, having checked the particulars of the buy-back campaign, displays the above-described new item purchase application page on the screen of user terminal 10₁, enters as input in this new item purchase application page prescribed personal data (such as name, address, telephone number, and e-mail address) as well as the maker and model number of the new item that user 1₁ wishes to purchase, and thus applies for the order and purchase of a new item. In sales center 2, moreover, the personal data on user 1₁ and the information such as the maker and model number of the new item that user 1₁ wishes to purchase that were entered as input in Step A102 are registered by information management unit 23 in user information DB 21 in correspondence with the order number of the new item that user 1₁ has ordered.

In Step A103, settlement unit 27 in sales center 2 withdraws from the account that user 1₁ has designated the purchase price of the new item that user 1₁ wishes to purchase. Sales center 2 further supplies to user 1₁ the new item that user 1₁ wishes to purchase and reports the order number of the new item to user 1₁.

In Step A104, user 1₁ uses user terminal 10, to access the Website of buy-back center 3 and displays the above-described preliminary estimation page on the screen of user terminal 10₁. User 1₁ then enters information into this preliminary estimation page such as the maker and model number of the used item as well the existence of any damage or operating defects and thus carries out a preliminary estimation of the buy-back price of the used item. User 1₁ may also carry out this preliminary estimation when checking the particulars of the buy-back campaign in Step A102.

Assuming that user 1₁ agrees with the buy-back price that results from this preliminary estimation, user 1₁ displays the above-described buy-back/campaign application page on the screen of user terminal 10₁ in Step A105. User 1₁ then enters the order number of the new item that user 1₁ has purchased at sales center 2 on this buy-back/campaign application page, and further, enters prescribed personal data (such as name, address, telephone number, and e-mail address) and information such as the maker and model number of the used item that user 1₁ wishes to have bought back, and applies for buy-back of the used item and participation in the campaign. In buy-back center 3, the order number of the new item, the personal data on user 1₁, and information such as the maker and model number of the used item that user 1₁ wishes to have bought back that were entered as input in Step A105 are registered in user information DB 31 by information management unit 33.

Accordingly, buy-back center 3 can obtain confirmation that user 1₁ has purchased a new item at sales center 2 by means of the above-described order number of the new item that user 1₁ was directed to enter as input when applying for buy-back. However, there is a possibility that the order number that user 1₁ enters as input is a number that has been improperly appropriated from another user and not a number obtained through the proper purchase of a new item from sales center 2 by user 1₁.

In order to eliminate an application for campaign and buy-back that uses an improperly appropriated order number, mail management unit 35 of buy-back center 3 transmits the personal data on user 1₁ and the information regarding the order number of the new item that were entered as input at the time of the an application for buy-back in Step A105 to sales center 2 by electronic mail in Step A106. Mail management unit 35 then requests confirmation that the personal data on user 1₁ that was entered at the time of application for buy-back matches with the personal data on user 1₁ that was registered in sales center 2 in correspondence with the order number at the time of application for purchase of the new item. If the personal data on user 1₁ matches, mail management unit 35 requests the transmission of information such as the maker and model number of the new item that user 1₁ purchased, that was registered in sales center 2 in correspondence with the above-described transmitted order number. Mail management unit 35 further transmits by electronic mail to sales center 2 information such as the maker or model number of the used item that user 1₁ wishes to have bought back. If the personal data on user 1₁ matches, mail management unit 35 then requests the transmission of information regarding the cash rebate amount that is to be awarded to user 1₁.

In Step A107, information management unit 23 in sales center 2 next searches user information DB 21 using the order number that has been transmitted in from buy-back center 3, and determines whether or not the personal data on user 1₁ that has been registered in user information DB 21 in correspondence with the order number matches with the personal data on user 1₁ that has been transmitted in from buy-back center 3. If the personal data on user 1₁ matches, information management unit 23 further searches user information DB 21 to obtain information such as the maker and model number of the new item that user 1₁ has purchased, and searches item information DB 22 to obtain information regarding the cash rebate amount that is to be awarded to user 1₁. Mail management unit 25 next transmits by electronic mail to buy-back center 3: the results of determining whether the personal data on user 1₁ matches, and, if the personal data on user 1₁ matches, information regarding the maker and model number of the new item that user 1₁ has purchased and information on the amount of the cash rebate. In buy-back center 3, the information on the maker and model number of the new item that user 1₁ has purchased and information on the cash rebate amount that have been transmitted in from sales center 2 in Step A107 are registered in user information DB 31 by information management unit 33.

In Step A108, if it is determined in buy-back center 3 that the personal data on user 1₁ that was entered as input at the time of application for buy-back matches with the personal data on user 1₁ that was registered in sales center 2 at the time of purchasing the new item, the used item of user 1₁ is collected by having user 1₁ bring in the item, having user 1₁ send in the item, or by dispatching someone to the residence or workplace of user 1₁ to pick up the item.

In Step A109, in order to make a final assessment in buy-back center 3 of the buy-back price of the used item that has been collected from user 1₁, not only information on the maker and model number, but also, information such as the existence of damage or operation defects that is obtained through a hands-on examination of the article is applied as input to input unit 36, whereby estimation/assessment unit 38 is able to calculate the buy-back price. Settlement unit 37 then simultaneously transfers the buy-back price that has been calculated by estimation/assessment unit 38 and the amount of cash rebate that has been reported from sales center 2 in Step A107 to the account that was designated by user 1₁.

Subsequently, in Step A110, mail management unit 35 of buy-back center 3 reports the buy-back results such as the maker and model number of the used item that has been bought back from user 1₁ to sales center 2 by electronic mail. In sales center 2, the information such as the maker and model number of the used item that user 1₁ has allowed buy-back center 3 to buy back that was reported from buy-back center 3 in Step A110 is registered in user information DB 21 by information management unit 23.

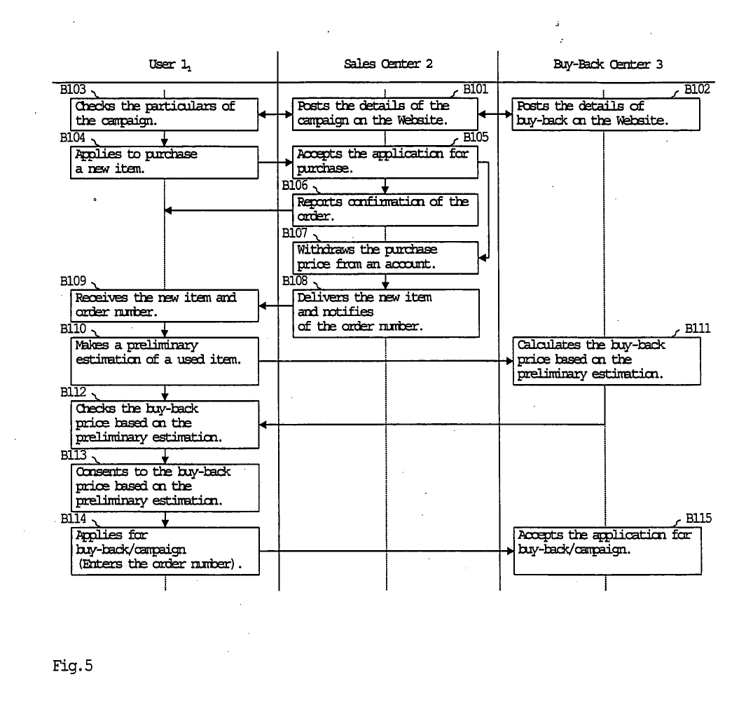

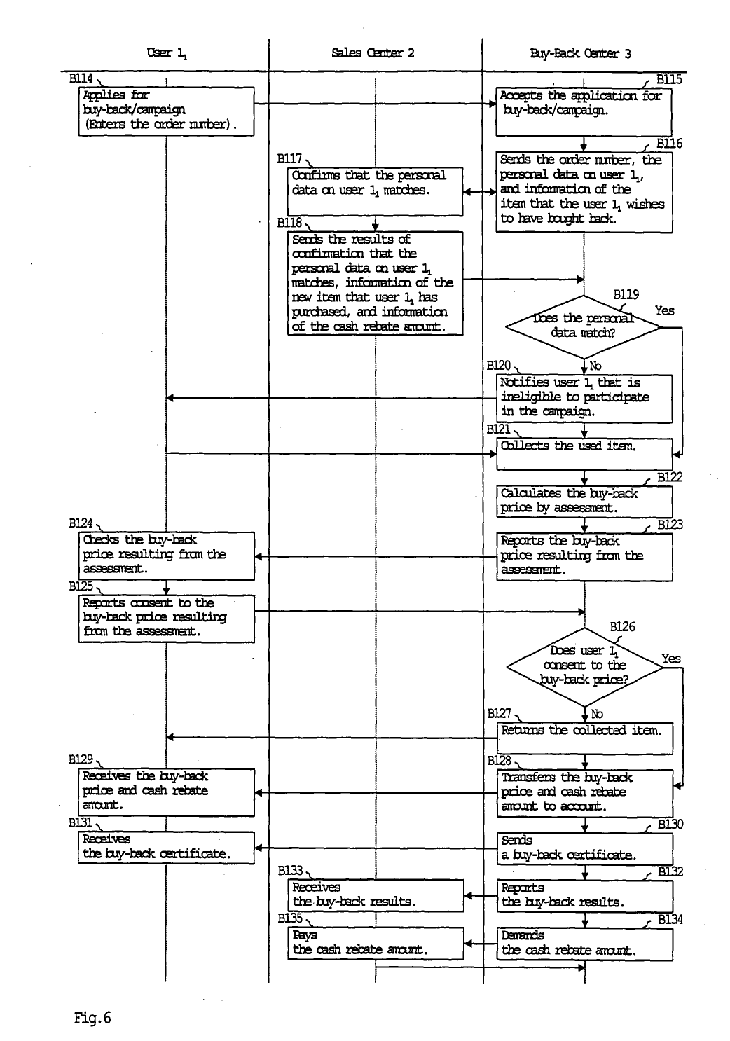

The method of buying back goods according to the first embodiment of the present invention is next explained in detail with reference to the flow charts of FIG. 5 and FIG. 6. In this case as well, user 1₁ is assumed to be a participant in a buy-back campaign, as in FIG. 3.

Referring now to FIG. 5, in Step B101, site management unit 24 of sales center 2 links each of the pages of the Website of sales center 2 as shown in FIG. 4 to post the details of the buy-back campaign on a campaign page. For example, information that is posted on the campaign page may include rules regarding participation in the campaign, the particulars of the campaign, the application procedures, the term of the campaign, limits on the number of participants (for example, a limitation to the first number-x of users that apply), limits on the number of items to be bought back (for example, a limitation to the first number-x of units), and other conditions (for example, one used item is to be bought back for every new item that is purchased).

Similarly, in Step B102, site management unit 34 of buy-back center 3 links each page of the Website of buy-back center 3 as shown in FIG. 4 and posts the details of the buy-back on the top page. For example, the information that is posted on the top page may include rules regarding the participation in buy-back, items that are targeted for buy-back, buy-back pricing (criteria), methods of retrieving PCs, the method of assessing and communicating the final buy-back price, the method of paying the buy-back amount, and other conditions (for example, one used item is to be bought back for every new item that is purchased). In addition, site management unit 34 of buy-back center 3 may produce a buy-back details page to which a user can jump from the top page and may post the above-described information on this buy-back details page.

In Step B103, user 1₁ next uses user terminal 10₁ to access the Website of sales center 2 or the Website of buy-back center 3 and checks the details of the buy-back campaign or the details of buy-back.

In Step B104, user 1₁ displays the above-described new item purchase application page on the screen of user terminal 10₁, enters as input on this new item purchase application page prescribed personal data (name, address, telephone number, e-mail address, etc.) as well as the maker and model number of the new item that user 1₁ wishes to buy, and applies for the order and purchase of the new item. In sales center 2, the personal data on user 1₁ that was received as input in Step B104 and information such as the maker and model number of the new item that user 1₁ wishes to purchase are registered by information management unit 23 in user information DB 21 in correspondence with the order number of the new item that user 1₁ has ordered.

In sales center 2, the order and purchase of the new item is accepted by the new item purchase application page in Step B105, whereupon mail management unit 25 reports a confirmation of the order to user 1₁ by e-mail in Step B106.

Settlement unit 27 in sales center 2 next withdraws the amount payable for the new item that user 1₁ has purchased from the account that has been designated by user 1₁ in Step B107. Next, in sales center 2, the new item that has been purchased by user 1₁ is delivered to user 1₁ and the order number of the new item that user 1₁ has ordered is reported to user 1₁ in Step B108 and Step B109. At this time, sales center 2 reports the above-described order number to user 1₁ by a method such as, for example, applying onto the packaging of the new item that is delivered to user 1₁ a statement of delivery or guarantee that discloses the order number.

In Step B110, user 1₁ next uses user terminal 10₁ to access the Website of buy-back center 3 and displays the above-described preliminary estimation page on the screen of user terminal 10₁. User 1₁ then performs a preliminary estimation by oneself of the buy-back price of the used item on this preliminary estimation page.

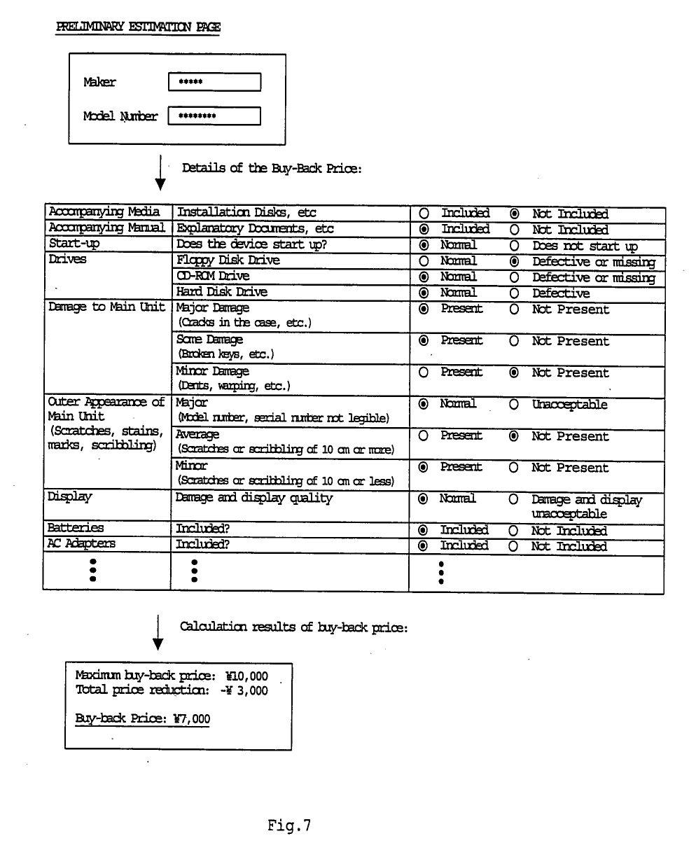

More specifically, user 1₁ first enters the maker and model number of the used item on the preliminary estimation page and checks the maximum buy-back price as shown in FIG. 7. If user 1₁ wishes to check a more detailed buy-back price, user 1₁ enters detailed information such as the presence or absence of damage and operation defects and thus obtains a buy-back price that is reduced from the maximum buy-back price by a total discount amount according to the existence of damage or operation defects. In addition, the preliminary estimation that is performed by user 1₁ may also be performed in Step B103 at the time of checking the particulars of the buy-back campaign.

In Step B111, estimation/assessment unit 38 in sales center 2 calculates the buy-back price of the item belonging to user 1₁ based on the information that was entered on the preliminary estimation page at the time that user 1₁ carried out the preliminary price estimate.

In Step B112, user 1₁ next checks the buy-back price that is displayed on the preliminary estimation page, and then agrees to this buy-back price in Step B113. In this case, user 1₁ displays the above-described buy-back/campaign application page on the screen of user terminal 10₁, and on this buy-back/campaign application page, applies for buy-back of the used item and participation in the campaign in Step B114.

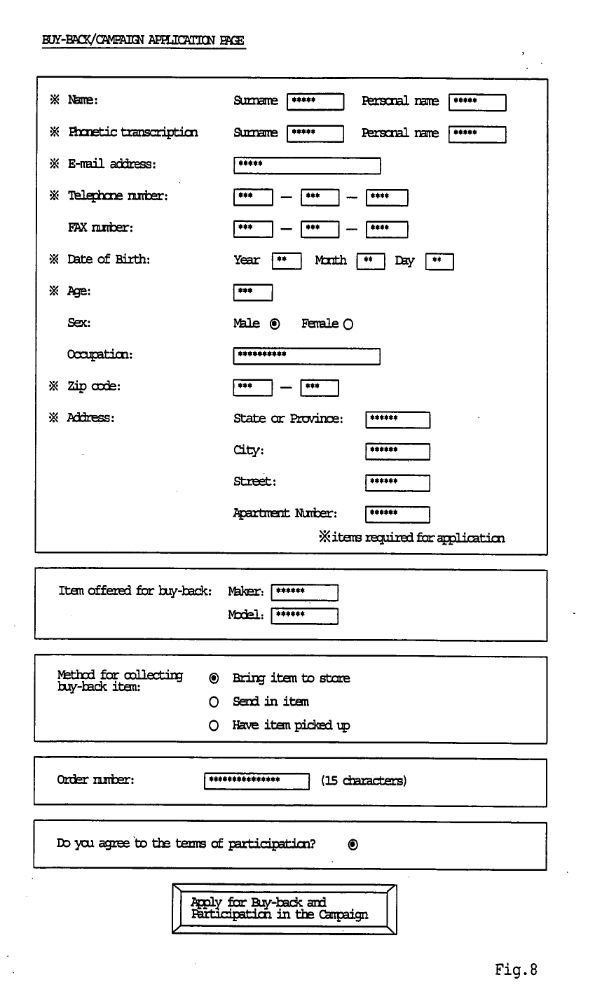

More specifically, as shown in FIG. 8, user 1₁ enters the order number of the new item that user 1₁ has ordered and purchased through sales center 2 on the buy-back/campaign application page and further, enters prescribed personal data (name, address, telephone number, e-mail address, etc.), the maker and model number of the used item user 1₁ wishes to have bought back, and the method of collecting the used item that user 1₁ wishes to have bought back. Having agreed to the rules of participation relating to buy-back of goods, user 1₁ applies for buy-back of the used item and participation in the campaign. These rules of participation include, for example, such rules as the refusal to accept the return to sales center 2 of a new item that has already been purchased in the event that user 1₁ does not consent to the final buy-back price of a used item and cancels participation in the buy-back campaign. In buy-back center 3, the personal data on user 1₁ that was entered as input in Step B114 and information regarding the maker and model number of the used item that user 1₁ wishes to have bought back are registered in user information DB 31 by information management unit 33.

Referring now to FIG. 6, the application for buy-back of a used item and participation in the campaign is accepted in buy-back center 3 on buy-back/campaign application page in Step B115, whereupon, in Step B116, mail management unit 35 transmits as e-mail to sales center 2 the order number of the new item and the personal data on user 1₁ that was entered as input at the time of the application for buy-back in Step B114. Mail management unit 35 then requests for confirmation that the personal data on user 1₁ that was entered as input at the time of the application for buy-back matches the personal data on user 1₁ that was registered in sales center 2 in correspondence with the order number at the time of application for purchase of the new item. If the personal data on user 1₁ matches, mail management unit 35 further requests for transmission of the information such as the maker and model number of the new item that user 1₁ purchased, that was registered in sales center 2 in correspondence with the order number that was transmitted as described above. In this case, mail management unit 35 need not send all of the personal data on user 1₁ that was entered in Step B114, but rather, need send only the required personal data. Mail management unit 35 further transmits to sales center 2 by means of e-mail information regarding the maker and model number of the used item that user 1₁ wishes to have bought back. If the personal data on user 1₁ matches, mail management unit 35 then requests for transmission of the information regarding the cash rebate amount that is to be awarded to user 1₁.

Next, in Step B117, information management unit 23 in sales center 2 searches user information DB 21 based on the order number that has been transmitted in from buy-back center 3 and determines whether or not the personal data on user 1₁ that has been registered in user information DB 21 in correspondence with the order number matches with the personal data on user 1₁ that was transmitted in from buy-back center 3. If the personal data on user 1₁ matches, information management unit 23 both searches user information DB 21 to obtain information regarding the maker and model number of the new item that user 1₁ purchased, and searches item information DB 22 to obtain information regarding the cash rebate amount that is to be awarded to user 1₁. Here, if the cash rebate amount varies in accordance with the maker or model of the new item that user 1₁ has purchased and/or the used item that user 1₁ has allowed to be bought back, information management unit 23 obtains information regarding the cash rebate amount that varies in accordance with the maker or model of the new item and/or the used item. Alternatively, if the cash rebate amount does not vary, information management unit 23 obtains information regarding the rebate amount. Next, in Step 118, mail management unit 25 transmits to buy-back center 3 by means of e-mail: the result of determining whether the personal data on user 1₁ matches, and if the personal data on user 1₁ matches, information on the maker and model number of the new item that user 1₁ purchased and information on the amount of the cash rebate. In buy-back center 3, information on the amount of the cash rebate and information on the maker and model number of the new item that user 1₁ has purchased that were sent in from sales center 2 in Step B118 are registered in user information DB 31 by information management unit 33.

If the personal data on user 1₁ that was entered as input at the time of application for buy-back does not match the personal data on user 1₁ that was registered in sales center 2 at the time of the application for purchasing the new item in Step B119 in buy-back center 3, a communication is issued by telephone or e-mail in Step B120 to report that user 1₁ is ineligible for a cash rebate.

On the other hand, if the personal data on user 1₁ that was entered as input at the time of the application for buy-back does match the personal data on user 1₁ that was registered in sales center 2 at the time of the application for purchase of a new item in Step B119 in buy-back center 3, the used item belonging to user 1₁ is collected by having user 1₁ bring in the item, by having user 1₁ send in the item, or by dispatching someone to the workplace or residence of user 1₁ to pick up the item in Step B121.

In buy-back center 3 in Step B122, a screen that is substantially the same as FIG. 5 is displayed on the display unit (not shown in the figure) of buy-back server 30 to assess the buy-back price of the used item that has been collected from user 1₁. In buy-back center 3, not only information on the maker and model number but detailed information regarding the presence of damage and operation defects that is obtained through a hands-on examination of the actual article is entered as input to input unit 36, and the buy-back price is then calculated by estimation/assessment unit 38. In Step B123 in buy-back center 3, the buy-back price that has been calculated by estimation/assessment unit 38 is then reported to user 1₁ by telephone or by e-mail as the final buy-back price.

User 1₁ checks the final buy-back price that has been obtained by the assessment of buy-back center 3 in Step B124 and then, in Step B125, reports consent or non-consent to buy-back center 3 by means of, for example, telephone or e-mail.

If user 1₁ does not consent to the final buy-back price in Step B126, buy-back center 3 returns to user 1₁ the used item that was collected from user 1₁ in Step B127.

On the other hand, if user 1₁ consents to the final buy-back price in Step B126, settlement unit 37 simultaneously transfers both the final buy-back price and the cash rebate amount that was checked in Step 118 to the account that was designated by user 1₁ in Steps B128 and B129. Furthermore, in Steps B130 and B131, buy-back center 3 either directly gives to user 1₁ a buy-back certificate certifying that user 1₁ has allowed buy-back center 3 to buy back a used item, or, for example, sends the certificate to user 1₁ by mail.

Subsequently, in Step B132 and Step B133, mail management unit 35 in buy-back center 3 reports by e-mail to sales center 2 the results of buy-back, i.e. , the maker and model number of the used item that has been bought back from user 1₁. In sales center 2, information management unit 23 registers in user information DB 21 the information that was reported from buy-back center 3 in Step B132 and Step B133 regarding the maker and model number of the used item that user 1₁ has allowed buy-back center 3 to buy back.

Further, in Step B134, a demand is issued by mail, telephone, or e-mail from buy-back center 3 to sales center 2 for the cash rebate amount that is to be awarded to user 1₁. In Step B135, settlement unit 27 of sales center 2 transfers the cash rebate amount to the account that is designated by buy-back center 3. The demand and payment of the cash rebate amount may also be effected before the payment of the cash rebate amount to user 1₁ in Steps B128 and B129. Alternatively, the payment of the cash rebate amount that is awarded to user 1₁ may also be borne by buy-back center 3, in which case the processing of Steps B134 and B135 is not necessary.

In the above-described embodiment, the buy-back center receives an application for buy-back of a used item by directing the user to enter the order number of a new item that was ordered and purchased through the sales center, and the buy-back center is therefore able to obtain confirmation by means of this order number that the user has purchased a new item through the sales center.

Accordingly, the buy-back center is able to receive an application for participation in a buy-back campaign at the same time that it accepts an application for buy-back of a used item. The number of applications relating to a buy-back campaign is therefore a total of two: the application for purchase of a new item and the application for participation in the campaign and for buy-back of a used item. The present embodiment can therefore reduce the number of applications compared to the prior art in which the total number of applications relating to a buy-back campaign was three, and can lighten the burden on the user.

In the present embodiment, moreover, the buy-back center proceeds with the process of buying back a used item after confirming that the personal data of a user that was entered as input at the time of a buy-back application matches the personal data of a user that was registered in the sales center at the time of purchase of a new item. The buy-back center is therefore able to eliminate an application for buy-back/campaign participation when the user that is applying for buy-back enters an order number that has been improperly appropriated from a different user.

In the present embodiment, moreover, the buy-back center is able to obtain information regarding a new item that a user has purchased from a sales center based on the order number that is entered as input at the time of application for buy-back of a used item and participation in a campaign. The buy-back center is therefore able to more efficiently buy back an article. The sales center is further able to obtain information on a used item that the buy-back center has bought back from a user from the buy-back results that are sent from the buy-back center upon conclusion of the buy-back of a used item.

Second Embodiment

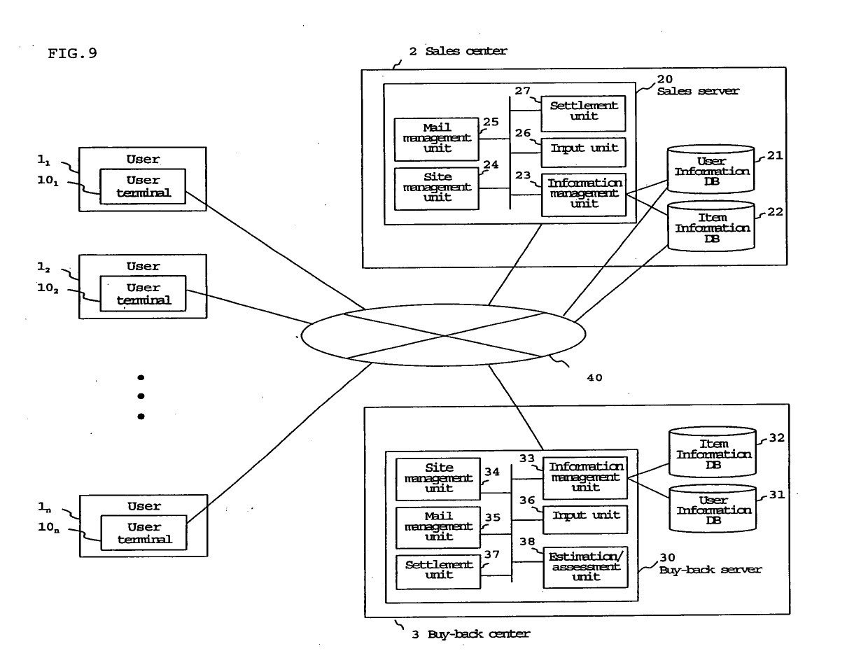

The method of buying back goods according to the second embodiment of the present invention uses the system for buying back goods that is shown in FIG. 9.

The system for buying back goods that is shown in FIG. 9 differs from the system for buying back goods that was shown in FIG. 2 in that user information DB 21 and item information DB 22 in sales center 2 are connected directly to network 40 and thus can be accessed directly from buy-back server 30 in buy-back center 3. Further, in buy-back server 30, information management unit 33 accesses and searches user information DB 21 and item information DB 22 in sales center 2. Apart from these points of difference, the construction of the system for buying back goods is identical to the system for buying back goods that is shown in FIG. 2, and redundant explanation is here omitted.

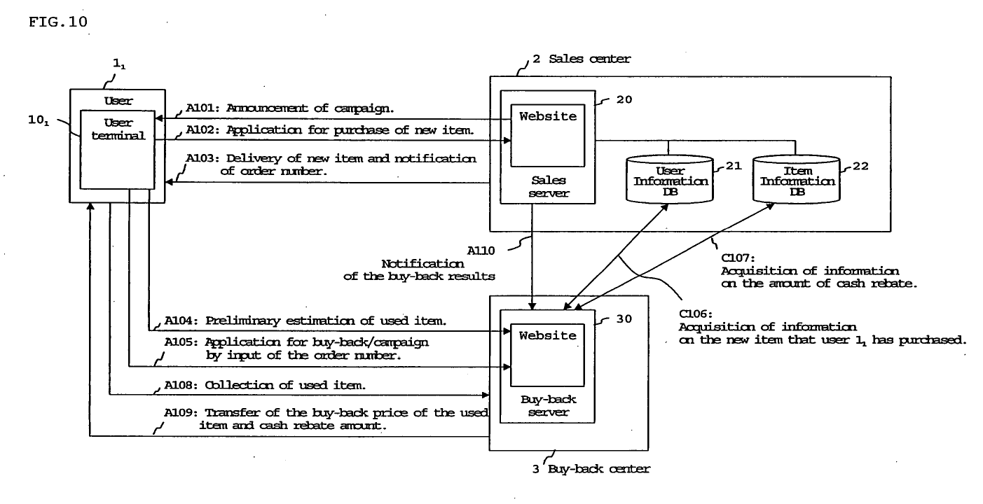

We next refer to FIG. 10 to describe the method of buying back goods according to the second embodiment of the present invention. The method of buying back goods that is shown in FIG. 10 is identical to the method of buying back goods that was shown in FIG. 3 with the exception that the processing of Step A106 and Step A107 has been modified.

The processing of Step A101 to Step A105 is first carried out as in the method of buying back goods that was shown in FIG. 3.

Next, in Step C106, information management unit 33 in buy-back center 3 directly accesses user information DB 21 in sales center 2 by way of network 40 and searches user information DB 21 based on the order number of the new item that was entered as input at the time of application for buy back in Step A105. Information management unit 33 then determines whether the personal data on user 1₁ that was registered in user information DB 21 in correspondence with the order number at the time of application for purchase of a new item matches the personal data on user 1₁ that was entered as input at the time of application for buy-back in Step A105. If the personal data on user 1₁ matches, information management unit 33 further searches user information DB 21 to obtain information regarding the maker and model number of the new item that user 1₁ has purchased.

In Step C107, moreover, if the personal data on user 1₁ matches, information management unit 33 in buy-back center 3 directly accesses item information DB 22 in sales center 22 and searches item information DB 22 to obtain information on the cash rebate amount that is to be awarded to user 1₁. In this case, if the cash rebate amount varies according to the maker and model of the new item that is purchased by user 1₁ and/or the used item that user 1₁ offers for buy-back, information management unit 33 obtains information on the cash rebate amount according to the maker and model of the new item and/or the used item. If the cash rebate amount does not vary, information management unit 33 obtains information on this amount. In buy-back center 3, information management unit 33 register's in user information DB 31 the information on the maker and model number of the new item that user 1₁ has purchased and the information on the cash rebate amount that were obtained in Steps C106 and C107.

Processing is subsequently carried out from Step A108 to Step A110 as in the method of buying back goods that was shown in FIG. 3.

In the present embodiment as described in the foregoing explanation, the total number of applications relating to a buy-back campaign can be reduced to two, as in the first embodiment, and the present embodiment can therefore reduce the number of applications compared to the prior art, in which the number of applications relating to a buy-back campaign was three, and can thus reduce the burden on the user.

In the present embodiment, moreover, as in the first embodiment, the buy-back center proceeds with the process of buying back a used item after confirming that the personal data of the user that was entered as input at the time of application for buy-back matches the personal data of the user that was registered in the sales center at the time of application for purchase of a new item. As a result, the buy-back center can eliminate applications for buy-back and participation in the campaign if the user that has applied for buy-back enters an order number that has been improperly appropriated from another user.

In the present embodiment, moreover, as in the first embodiment, the buy-back center can obtain information on a new item that a user has purchased from the sales center based on the order number that was entered as input at the time of application for participation in the campaign and buy-back of a used item. The buy-back center can therefore proceed with the buy-back of goods more efficiently. Further, the sales center can obtain information on a used item that the buy-back center has bought back from a user from the results of buy-back that are transmitted from the buy-back center upon conclusion of buy-back of a used item.

Third Embodiment

The method of buying back goods according to the third embodiment of the present invention employs the system for buying back goods that is shown in FIG. 2.

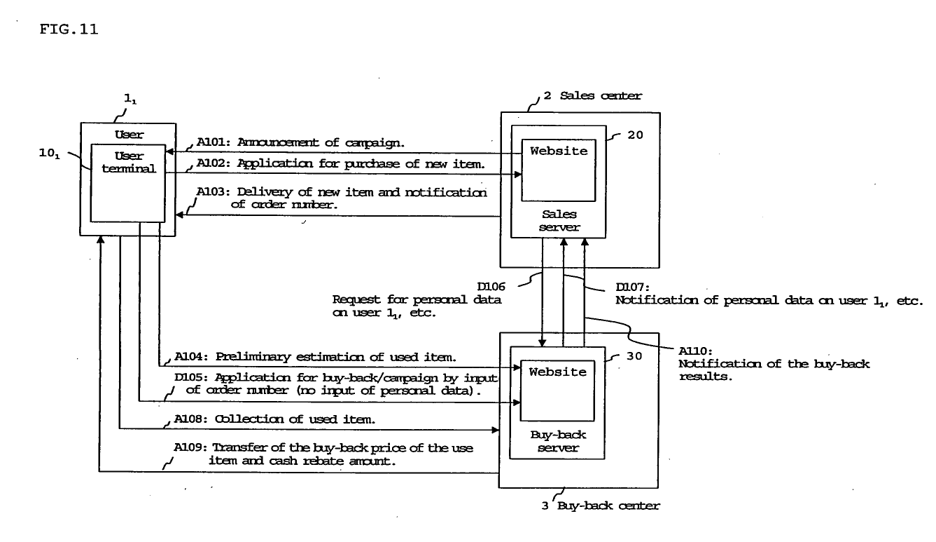

The method of buying back goods according to the third embodiment of the present invention is next explained with reference to FIG. 11. The method of buying back goods that is shown in FIG. 11 is identical to the method of buying back goods that was shown in FIG. 3 with the exception of the modification of the processes of Step A105, Step A106, and Step A107.

The processes of Step A101 to Step A104 are first carried out as in the method of buying back goods that was shown in FIG. 3.

If user 1₁ consents to the buy-back price that is produced by the preliminary estimation that was checked in Step A104, user 1₁ displays the above-described buy-back/campaign application page on the screen of user terminal 10₁ in Step D105. User 1₁ then applies for buy-back of the used item and participation in the campaign by entering the order number of the new item that user 1₁ ordered and purchased through sales center 2 and the maker and model number of the used item that user 1₁ wishes to have bought back on the buy-back/campaign application page but without entering the prescribed personal data (name, address, telephone number, e-mail address, etc.).

Next, in Step D106, mail management unit 35 in buy-back center 3 sends by e-mail to sales center 2 the information on the order number of the new item that was entered as input at the time of application for buy-back in Step D105. Mail management unit 35 then requests the transmission of the personal data on user 1₁ that was registered in sales center 2 in correspondence with the order number at the time of application for the purchase of the new item. Mail management unit 35 further transmits to sales center 2 by means of e-mail information on the maker and model number of the used item that user 1₁ wishes to have bought back. Mail management unit 35 then requests transmission of information on the cash rebate amount that is to be awarded to user 1₁.

In Step D107, information management unit 23 in sales center 2 searches user information DB 21 based on the order number that has been transmitted in from buy-back center 3 and obtains both the personal data on user 1₁ and the information on the maker and model number of the new item that user 1₁ has purchased that have been registered in user information DB 21 in correspondence with this order number. Information management unit 23 further searches item information DB 22 to obtain information on the cash rebate amount that is to be awarded to user 1₁. If the cash rebate amount here varies according to the maker and model number of the new item that user 1₁ has purchased and/or the used item that is bought back from user 1₁, information management unit 23 obtains information on the cash rebate amount that depends on the maker and model of the new item and/or the used item. If the cash rebate amount does not vary, information management unit 23 simply obtains the information on this rebate amount. Mail management unit 25 next transmits to buy-back center 3 by e-mail the personal data on user 1₁, the information on the maker and model number of the new item that user 1₁ has purchased, and the information on the cash rebate amount. In buy-back center 3, the personal data on user 1₁, information regarding the maker and model number of the new item that user 1₁ purchased, and information on the cash rebate amount that were transmitted in from sales center 2 in Step D107 are registered in user information DB 31 by information management unit 33.

The processing of Step A108 to Step A110 is subsequently carried out as in the method of buying back goods that was shown in FIG. 3.

In the present embodiment as described in the foregoing explanation, the number of applications relating to a buy-back campaign can be reduced to two as with the first embodiment. The present embodiment therefore enables a reduction of the number of applications compared to the prior art, in which the number of applications relating to a buy-back campaign was three, and as a result, enables a reduction of the load on a user.

In the present embodiment, moreover, there is no need to enter personal data as input when applying for buy-back of a used item and participation in the campaign, and the present embodiment therefore has the advantage of enabling a further reduction of the load on a user as compared to the first embodiment. When a user who is applying for buy-back enters an order number that has been improperly appropriated from another user, however, the buy-back of the article is carried out for another user that is registered in user information DB 21. It is therefore preferable that the buy-back center have registered user 1₁ confirm the buy-back by, for example, e-mail.

In the present embodiment, moreover, as in the first embodiment, the buy-back center can obtain information regarding the new item that the user purchased from sales center based on the order number that was entered as input at the time of application for buy-back of a used item and participation in the campaign. As a result, the buy-back center can carry out buy-back more efficiently, and further, the sales center can obtain information on the used item that the buy-back center has bought back from the user from the buy-back results that are transmitted from the buy-back center upon conclusion of the buy-back of a used item.

Fourth Embodiment

The method of buying back goods according to the fourth embodiment of the present invention employs the system for buying back goods that is shown in FIG. 9.

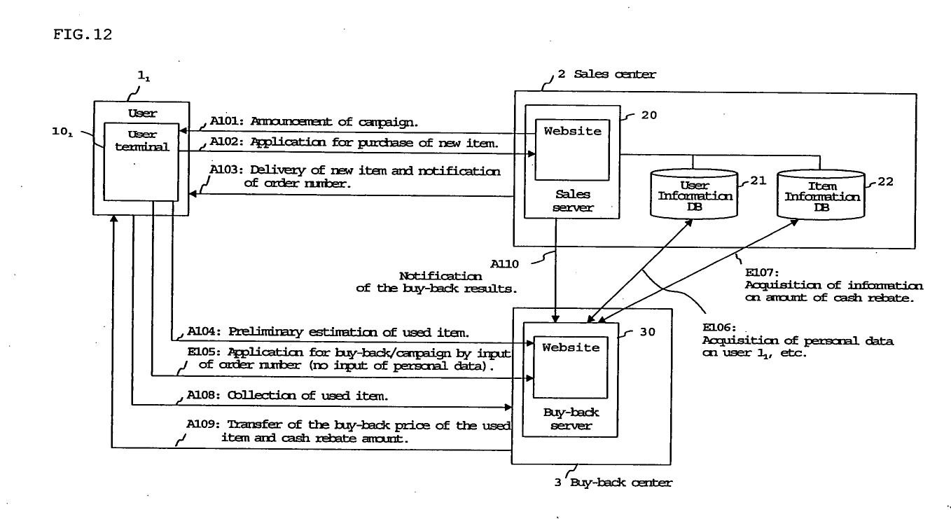

We next refer to FIG. 12 to explain the method of buying back goods according to the fourth embodiment of the present invention. The method of buying back goods that is shown in FIG. 12 is identical to the method of buying back goods that was shown in FIG. 10 with the exception of modifications of the processes of Step A105, Step C106, and Step C107.

The processing of Step A101 to Step A104 is first carried out as in the method of buying back goods that was shown in FIG. 10.

If user 1₁ consents to the buy-back price that was produced by the preliminary estimation checked in Step A104, user 1₁ displays the above-described buy-back/campaign application page on the screen of user terminal 10₁ in Step E105. User 1₁ then enters as input the order number of the new item that user 1₁ ordered and purchased through sales center 2 and information on the maker and model number of the used item that user 1₁ wishes to have bought back on the buy-back/campaign application page to apply for buy-back of the used item and participation in the campaign, but user 1₁ does not enter prescribed personal data (name, address, telephone number, e-mail address, etc.).

Next, in Step E106, information management unit 33 in buy-back center 3 directly accesses user information DB 21 in sales center 2 by way of network 40 and searches user information DB 21 based on the order number of the new item that was entered at the time of application for buy-back in Step 105. Information management unit 33 then obtains the personal data on user 1₁ that was registered in user information DB 21 in correspondence with the order number at the time of the application for purchase of the new item and information on the maker and model number of the new item that user 1₁ purchased.

In Step E107, information management unit 33 in buy-back center 3 directly accesses item information DB 22 in sales center 2 and searches item information DB 22 to obtain information on the cash rebate amount that is to be awarded to user 1₁. If the cash rebate amount varies according to the maker and model of the new item that user 1₁ has purchased and/or the maker and model of the used item that user 1₁ wishes to have bought back, information management unit 33 obtains information on the cash rebate amount according to the maker and model of the new item and/or the used item. If the cash rebate amount does not vary, information management unit 33 simply obtains the information on the rebate amount. In buy-back center 3, the personal data on user 1₁, information on the maker and model number of the new item that user 1₁ has purchased and information on the cash rebate amount that were obtained in Step E106 and Step E107 are registered in user information DB 31 by information management unit 33.

Processing subsequently continues from Step A108 to Step A110 as in the method of buying back goods that was shown in FIG. 10.

As with the second embodiment, the present embodiment as described in the foregoing explanation can reduce the number of applications relating to a buy-back campaign to a total of two. The present embodiment therefore enables fewer applications than the prior art, in which the number of applications relating to a buy-back campaign was three, and further, enables a reduction of the burden on the user.

The present embodiment has the advantage of enabling a greater reduction of the burden on the user than the second embodiment because there is no need to enter personal data when applying for buy-back of a used item and participation in a campaign. However, when a user that is applying for buy-back enters an order number that has been improperly appropriated from another user, the procedure of buying back goods is carried out for the other user that is registered in user information DB 21. It is therefore preferable that the buy-back center have registered user 1₁ confirm the buy-back by e-mail.

As in the second embodiment, the buy-back center in the present embodiment is able to obtain information on the new item that the user has purchased from the sales center based on the order number that is entered as input at the time of application for buy-back of a used item and participation in the campaign. The buy-back center is therefore able to more efficiently handle the buy-back of goods. In addition, the sales center is able to obtain information on a used item that the buy-back center has bought back from a user based on the buy-back results that are transmitted in from the buy-back center upon conclusion of the buy-back of a used item.

Although the first to fourth embodiments were described for a case in which users who participate in a buy-back campaign are awarded with a cash rebate, points or giveaways may also be awarded instead of a cash rebate. In such cases, the points or giveaways may vary according to the maker or model of the new item that the user has purchased or the used item that is bought back, or points or giveaways may remain uniform. Further, the process of paying the buy-back price of used items and the process of awarding points or giveaways may be carried out at the same time.

While preferred embodiments of the present invention have been described using specific terms, such description is for illustrative purposes only, and it is to be understood that changes and variations may be made without departing from the spirit or scope of the following claims.

What is claimed is:

1. A method of buying back goods, comprising steps of:
at a sales center, designating a buy-back center to a user that has purchased goods that are a targeted item;
at said buy-back center, directing said user to enter as input the order number of the goods that were purchased through said sales center at a Website on a network and accepting an application for buy-back of a used item; and
at said buy-back center, having confirmed that said user has purchased goods from said sales center based on said order number, giving said user a prescribed benefit.

2. A method of buying back goods according to claim 1, further comprising steps of:
at said Website of said sales center on a network, accepting an application for purchase of goods by directing said user to enter as input personal data of said user;
registering said personal data of said user that said sales center has directed said user to enter as input when applying for purchase and information relating to goods that said user purchased in correspondence with said order number in a user information database in said sales center;
registering in advance information on the particulars of a benefit that is to be given to said user by said sales center in an item information database in said sales center; and
obtaining, by said buy-back center, information relating to said user from said user information database and/or said item information database in said sales center based on said order number that said user is directed to enter as input when applying for buy-back.

3. A method of buying back goods according to claim 2, further comprising steps of:
accepting an application for buy-back at a Website of said buy-back center by directing said user to enter as input both said order number and said personal data of said user;
transmitting by way of said network from said buy-back center to said sales center said order number and said personal data of said user that said user was directed to enter as input at the time of application for buy-back;
checking at said sales center for matching of said personal data that is registered in said user information database in correspondence with said order number that was transmitted in from said buy-back center with said personal data that was transmitted in from said buy-back center; and
having confirmed that said personal data matches, obtaining at said sales center information relating to said user from said user information database and/or said item information database in said sales center and transmitting said obtained information to said buy-back center by way of said network.

4. A method of buying back goods according to claim 3, wherein:
said information relating to said user is information relating to goods that said user has purchased that is registered in correspondence with said order number in said user information database in said sales center, and/or information on the particulars of a benefit that is to be given to said user that is registered in said item information database in said sales center.

5. A method of buying back goods according to claim 3, wherein:
said buy-back center proceeds with a process of buying back a used item from said user only when said personal data of said user that said user was directed to enter as input when applying for buy-back matches said personal data of said user that is registered in said user information database in said sales center.

6. A method of buying back goods according to claim 4, wherein:
said particulars of the benefit that is given to said user vary according to the maker or model of the goods that said user purchases from said sales center and/or the used item that said buy-back center buys back from said user.

7. A method of buying back goods according to claim 2, comprising steps wherein:
an application for buy-back is accepted by directing said user to enter as input personal data of said user together with said order number at the Website of said sales center;
said buy-back center directly accesses said user information database in said sales center by way of said network and checks whether said personal data that is registered in said user information database in said sales center in correspondence with said order number that said user was directed to enter as input when applying for buy-back matches said personal data that said user was directed to enter as input when applying for buy-back; and
said buy-back center, having confirmed that said personal data matches, directly accesses said user information database and/or said item information database in said sales center by way of said network and obtains information relating to said user.

8. A method of buying back goods according to claim 7, wherein:
said information relating to said user is information relating to goods that said user has purchased that is registered in correspondence with said order number in said user information database in said sales center, and/or information on the particulars of a benefit that is to be given to said user that is registered in said item information database in said sales center.

9. A method of buying back goods according to claim 7, wherein:
said buy-back center proceeds with the process of buying back a used item from said user only when said personal data of said user that said user was directed to enter as input when applying for buy-back matches said personal data of said user that is registered in said user information database in said sales center.

10. A method of buying back goods according to claim 2, further comprising steps wherein:
said order number that said user was directed to enter as input when applying for buy-back is transmitted from said buy-back center to said sales center by way of said network; and
said sales center, based on said order number that has been transmitted from said buy-back center, obtains information relating to said user from said user information database and/or said item information database in said sales center and transmits said obtained information relating to said user to said buy-back center by way of said network.

11. A method of buying back goods according to claim 10, wherein:
said information relating to said user is: said personal data of said user and information relating to goods that said user has purchased that are registered in correspondence with said order number in said user information database in said sales center; and/or information on the particulars of a benefit that is to be given to said user that is registered in said item information database in said sales center.

12. A method of buying back goods according to claim 11, wherein:
said particulars of the benefit that is given to said user vary according to the maker or model of the goods that said user purchases from said sales center and/or the used item that said buy-back center buys back from said user.

13. A method of buying back goods according to claim 2, further comprising a step wherein:
based on said order number that said user was directed to enter as input when applying for buy-back, said buy-back center directly accesses by way of said network said user information database and/or said item information database in said sales center to obtain information relating to said user.

14. A method of buying back goods according to claim 13, wherein:
said information relating to said user is: said personal data of said user and information relating to goods that said user has purchased that are registered in correspondence with said order number in said user information database in said sales center; and/or information on the particulars of a benefit that is to be given to said user that is registered in said item information database in said sales center.

15. A method of buying back goods according to claim 14, wherein:
said particulars of the benefit that is given to said user vary according to the maker or model of the goods that said user purchases from said sales center and/or the used item that said buy-back center buys back from said user.

16. A method of buying back goods according to claim 1, further comprising a step wherein:
said buy-back center simultaneously carries out a process of paying the buy-back price of a used item to said user and a process of giving a benefit to said user.

17. A method of buying back goods according to claim 1, further comprising a step wherein:
said buy-back center, after completing the process of paying the buy-back price of a used item to said user, transmits to said sales center by way of said network buy-back results that include information relating to the used item that has been bought back from said user.

18. A system for buying back goods, comprising:
a sales center for marketing target goods; and
a buy-back center, being designated by said sales center to users that have purchased target goods, said buy-back center including a buy-back server for operating a Website on a network for accepting applications to buy back used items by directing said users to enter as input the order numbers of goods that said users have purchased through said sales center, and for giving a prescribed benefit to users after confirming, based on said order number, that these users have purchased goods from said sales center.

19. A system for buying back goods according to claim 18, wherein:
said sales center includes a sales server that is equipped with:
means for operating a Website on said network for directing said users to enter as input personal data of said users and accepting applications to purchase goods; and
means for registering, in correspondence with said order number in a user information database in said sales center, said personal data of said users that said users are directed to enter as input when applying to purchase goods and information relating to goods that said users have purchased; and further, for registering in advance in an item information database in said sales center, information on the particulars of benefits that are to be given to said users;
and said buy-back server obtains information relating to said users from said user information database and/or said item information database in said sales center based on said order numbers that said users are directed to enter as input when applying for buy-back.

20. A system for buying back goods according to claim 19, wherein:
said buy-back server comprises:
site management means for managing a Website that directs said users to enter as input personal data of said users together with said order numbers and accepts applications for buy-back of used items; and
communication means for transmitting, to said sales server by way of said network, said order numbers and said personal data of said users that said users are directed to enter as input when applying for buy-back; and
said sales server comprises:
information management means for, after confirming that said personal data that is registered in said user information database in correspondence with said order numbers that have been transmitted in from said buy-back server matches personal data that has been transmitted in from said buy-back server, obtaining information relating to said users from said user information database and/or said item information database in said sales center; and
communication means for transmitting, to said buy-back server by way of said network, information relating to said users that has been obtained by said information management means from said user information database and/or said item information database.

21. A system for buying back goods according to claim 20, wherein:
said information relating to said users is information relating to goods that said users have purchased that is registered in correspondence with said order numbers in said user information database in said sales center, and/or information on the particulars of the benefits that are to be given to said users that is registered in said item information database in said sales center.

22. A system for buying back goods according to claim 20, wherein:
the process of buying back used items from said users by means of said buy-back center proceeds only when said personal data of said users that said users have been directed to enter as input when applying for buy-back by at said buy-back center matches with said personal data of said users that is registered in said user information database in said sales center.

23. A system for buying back goods according to claim 21, wherein:
said particulars of the benefits that are given to said users vary according to the maker or model of the goods that said users have purchase from said sales center and/or the used items that said buy-back center buys back from said users.

24. A system for buying back goods according to claim 19, wherein said buy-back server comprises:
site management means for managing a Website that directs said users to enter as input personal data of said users together with said order numbers and accepts applications to buy back used items; and
information management means for directly accessing said user information database in said sales center by way of said network, and after confirming that said personal data that is registered in said user information database in correspondence with said order number that said user was directed to enter as input when applying to purchase goods matches said personal data that said user was directed to enter as input when applying for buy-back, for directly accessing said user information database and/or said item information database in said sales center by way of said network and obtaining information relating to said user.

25. A system for buying back goods according to claim 24, wherein:
said information relating to said user is information relating to goods that said user has purchased that is registered in correspondence with said order number in said user information database in said sales center, and/or information on the particulars of the benefits that are to be given to said user that is registered in said item information database in said sales center.

26. A system for buying back goods according to claim 24, wherein:
the process of buying back used items from said users by said buy-back center proceeds only when said personal data of said users that said users have been directed to enter as input when applying for buy-back at said buy-back center matches with said personal data of said users that is registered in said user information database in said sales center.

27. A system for buying back goods according to claim 19, wherein:
said buy-back server comprises:
site management means for managing a Website that directs said users to enter as input said order number and accepts applications to buy back used items; and
communication means for transmitting, to said sales server by way of said network, said order numbers that said users were directed to enter as input when applying for buy-back; and
said sales server comprises:
information management means for obtaining, based on said order numbers that have been transmitted from said buy-back server, information relating to said users from said user information database and/or said item information database in said sales center; and
communication means for transmitting, to said buy-back server by way of said network, information relating to said users that has been obtained by said information management means from said user information database and/or said item information database.

28. A system for buying back goods according to claim 27, wherein:
said information relating to said users is said personal data of said users and information relating to goods that said users have purchased that are registered in correspondence with said order numbers in said user information database in said sales center, and/or information on the particulars of the benefits that are to be given to said users that is registered in said item information database in said sales center.

29. A system for buying back goods according to claim 28, wherein:
said particulars of benefits that are to be given to said users vary according to the maker or model of goods that said users have purchased from said sales center and/or the used items that said buy-back center buys back from said users.

30. A system for buying back goods according to claim 19, wherein said buy-back server comprises:
site management means for managing a Website that directs said users to enter as input said order numbers and accepts applications to buy back used items; and
information management means for directly accessing said user information database and/or said item information database in said sales center by way of said network based on said order numbers that said users are directed to enter as input when applying for buy-back and obtaining information relating to said users.

31. A system for buying back goods according to claim 30, wherein:
said information relating to said users is said personal data of said users and information relating to goods that said users have purchased that are registered in correspondence with said order numbers in said user information database in said sales center, and/or information on the particulars of benefits that are to be given to said users that is registered in said item information database in said sales center.

32. A system for buying back goods according to claim 31, wherein:
said particulars of benefits that are to be given to said users vary according to the maker or model of the goods that said users have purchased from said sales center and/or the used items that said buy-back center buys back from said users.

33. A system for buying back goods according to claim 18, wherein:
said buy-back server includes means for simultaneously executing a process of paying the buy-back prices of used items to said users and a process of giving benefits to said users.

34. A system for buying back goods according to claim 18, wherein:
said buy-back server includes means for transmitting, to said sales server by way of said network, results of buy-back that include information relating to the used items that have been bought back from said users after completing the process of paying the buy-back prices of the used items to said users.

35. A sales server that is provided in a sales center for marketing target goods to users, said sales server comprising:
site management means for managing a Website on a network that directs said users to enter as input personal data of said users and accepts applications to purchase goods; and
information management means for registering, in a user information database in said sales center, personal data of said users that said users were directed to enter as input when applying to purchase goods and information relating to goods that said users have purchased in correspondence with order numbers of said goods that said users have purchased; and further, for registering in advance in an item information database in said sales center information on the particulars of benefits that are to be given to said users when said users allow a specific buy-back center to buy back targeted used items; and moreover, for obtaining information relating to said users from said user information database and/or said item information database when said order numbers have been transmitted in from said buy-back center by way of said network; and
communication means for transmitting, to said buy-back center by way of said network, information relating to said users that has been obtained from said user information database and/or said item information database by said information management means.

36. A sales server according to claim 35, wherein:
said information relating to said users is information relating to goods that said users have purchased that is registered in said user information database in correspondence with said order numbers and/or information on the particulars of benefits that are to be given to said users that is registered in said item information database.

37. A sales server according to claim 36, wherein:
said particulars of benefits that are to given to said users vary according to the maker and model of goods that said users have purchased from said sales center and/or used items that said buy-back center has bought back from said users.

38. A sales server according to claim 35, wherein:
said information relating to said users is said personal data of said users and information-relating to goods that said users have purchased that are registered in said user information database in correspondence with said order numbers and/or information on the particulars of benefits that are to be given to said users that is registered in said item information database.

39. A sales server according to claim 38, wherein:
said particulars of benefits that are to given to said users vary according to the maker and model of goods that said users have purchased from said sales center and/or used items that said buy-back center has bought back from said users.

40. A buy-back server that is provided in a buy-back center for buying back used items that are targeted goods, said buy-back server comprising:
site management means for managing a Website on a network that directs said users to enter as input the order numbers of goods that said users have purchased through a specific sales center and that accepts applications for buy-back of used items that are targeted goods; and
means for carrying out a process of giving prescribed benefits to said users after confirming that said users have purchased goods from said sales center based on said order numbers.

41. A buy-back server according to claim 40, further comprising:
means for obtaining information relating to said users from said sales center based on said order numbers that said users are directed to enter as input when applying for buy-back.

42. A buy-back server according to claim 41, wherein:
said information relating to said users is information relating to goods that said users have purchased and/or information on the particulars of benefits that are to be given to said users.

43. A buy-back server according to claim 42, wherein:
said particulars of benefits that are to be given to said users vary according to the maker and model of goods that said users have purchased from said sales center and/or used items that said buy-back center has bought back from said users.

44. A buy-back server according to claim 41, wherein:
said information relating to said users is personal data of said users, information relating to goods that said users have purchased, and/or information on particulars of benefits that are to be given to said users.

45. A buy-back server according to claim 44, wherein:
said particulars of benefits that are to be given to said users vary according to the maker or model of goods that said users have purchased from said sales center and/or used items that said buy-back center has bought back from said users.

46. A buy-back server according to claim 40, further comprising:
means for simultaneously carrying out a process of paying the buy-back prices of used items to said users and a process of giving said benefits to said users.

47. A buy-back server according to claim 40, further comprising:
means for transmitting, to said sales center by way of said network, buy-back results that include information relating to used items that have been bought back from said users after completing the process of paying buy-back prices of used items to said users.
